(19) United States
(12) Patent Application Publication
(10) Pub. No.: US 2024/0010486 A1
(43) Pub. Date: Jan. 11, 2024

(54) A DIGITAL BEVERAGE FONT LENS

(71) Applicant: CARLSBERG BREWERIES A/S, Copenhagen V (DK)

(72) Inventors: Peter BACH, Copenhagen V (DK); Ricardo TEIXEIRA, Copenhagen V (DK); Ricardo SILVA, Copenhagen V (DK); Kaare Zoffmann JESSEN, Copenhagen V (DK)

(21) Appl. No.: 18/246,525

(22) PCT Filed: Oct. 5, 2021
(86) PCT No.: PCT/EP2021/077403

§ 371 Date: Mar. 24, 2023

(30) Foreign Application Priority Data
Oct. 5, 2020 (EP) 20200106.1

(51) Int. Cl. B67D 1/08; G09F 23/06

(52) U.S. Cl. CPC B67D 1/0877; G09F 23/06; B67D 1/0881

(57) ABSTRACT

The present disclosure relates to a beverage font lens comprising a housing accommodating a customer display panel embedded in the housing and visible through a first window; an operator display panel embedded in the housing and visible through a second window opposite the first window; and a microcontroller unit configured to display information on the customer display panel and the operator display panel. The present disclosure further relates to an information system for monitoring a beverage dispensing system, said information system comprising one or more measuring devices, one or more electronic devices, at least one cloud server suitable for cloud computing, and one or more microcontroller units, each of said microcontroller units embedded in a beverage font lens.

The present disclosure relates to a digital beverage font lens. It further relates to a beverage dispensing system for dispensing a beverage and an information system for monitoring a beverage dispensing system.

### BACKGROUND OF INVENTION

Typically, beverage dispensing systems used in beverage dispensing establishments such as bars and pubs comprise many different types of beverages to provide a selection for the customer being served at the bar. Accordingly, the beverage dispensing system often comprises multiple different beverage containers or kegs, each beverage container containing a specific type of beverage. The different types of beverage often include carbonated alcoholic beverages such as draught beer and cider, but other beverages such as non-alcoholic beers, soft drinks and non-carbonated beverages such as wine and fruit juice may also be provided by the beverage dispensing system.

The beverage dispensing systems mentioned above typically comprise a beverage font with one or more tapping heads, each tapping head operated by a tap handle, and each tapping head associated with a specific beverage container of the beverage dispensing system. Since the beverage containers are often hidden to the customer, a beverage font lens is typically provided near the beverage font, often directly above each tapping head of the beverage font. Each beverage font lens then provides information to the customer on which type of beverage, e.g. the brand, is being dispensed from the particular tapping head, such that the customer is able to make a selection from the available types of beverages. Such beverage font lenses are widely known in the industry.

In general, there is a lot of information associated with a beverage dispensing system, wherein some of the information is relevant to the bartender and some to the customer. The information that is relevant to a bartender or a bar manager typically includes the time when a given beverage container was installed (in order to keep track of the shelf life of a given beverage), the type of beverage contained in each beverage container, the remaining volume of each beverage container, the dispensed volume from each container during predefined time intervals (in order to evaluate the popularity of a given beverage), cleaning intervals, among other information. In existing beverage dispensing systems, the bartender often has to keep track of this information manually e.g. by inspecting the system. Hence there is a need of a more digitalised beverage dispensing system, wherein the relevant information is automatically collected e.g. from a variety of sensors monitoring the system, and wherein the information is processed and displayed to the bartender, thereby providing the bartender with a better overview of the entire beverage dispensing system. Such systems are for example described in WO2018/194601, WO2018/236758 and WO 2019/158562 using for example a tablet located on the counter to display the information. An ideal place for presenting such information to the bartender/bar manager is on the part of the beverage font lens facing the bartender, since this is right in front of the bartender when he is operating the tap handle(s). Examples of displaying information to the bartender on the beverage font are described in WO2018/236758 and WO2019/158562, these are however not displayed on the beverage lens as such, but on the tapping heads. The disadvantage of having information on the tapping head is that it is not visible to the customer or the operator when the tap is pulled down to dispense the beverage.

Existing beverage font lenses are often illuminated, e.g. by LEDs, to catch the attention of the guests at the bar. The illumination of the beverage font lens may also be provided for aesthetic purposes. However, oftentimes the information provided in the beverage font lens is static. An example could be the brand of the beverage type being dispensed from each tapping head. If the beverage on the tap is changed the font lens needs to be changed. Hence, there is a need to provide dynamic information in the beverage font lens, wherein said information can be updated or changed without changing the beverage font lens. Furthermore, a dynamic beverage font lens could also provide information from the bar to the customer such as happy hour, special promotions or entertainment. An example of a digital display providing advertisement to customers are described in US2017/0174496, this is however not integrated in the beverage font lens.

A beverage font lens that in addition to the information to the customer also is able to provide real-time information to an operator, e.g. a bartender or bar manager, wherein said information is relevant for the operator while not necessarily relevant for the customer, would be a benefit.

US2015/0368086 describes a beverage lens with a screen on one side for displaying information. There are two modes for displaying the information on the screen, where a first normal display mode presents the brand of the beer in an animated or still picture, and where a second diagnostic mode presents e.g. information about the beverage container or keg status. The lens is square and does not easily blend in with the classic beverage font lenses and will require completely new hardware to be installed. In addition, the lens is integrated in the tap handle. As a consequence, every time the bartender operates the tap handle of US2015/368086, the displays change position/are rotated and may not be visible to the customer and/or bartender.

WO2019/158563 discloses a beverage dispensing system, wherein information about the system is automatically collected, processed, and displayed to a user.

In summary, there is a need of a digitalised beverage dispensing system, wherein information relevant to the bartender is automatically collected and presented at the bar and which can be retrofitted to existing beverage font lenses such that they provide dual-side information, i.e. information relevant to the customers being served at the bar, and other information relevant to the bartender operating the beverage dispensing system. This information should ideally be easy and fast to update without changing the beverage font lens. Finally, solutions are needed that are able to replace existing illuminated beverage font lenses, wherein the replacement is easy to install, preferably by replacing as little of the hardware already present in the existing beverage font lenses.

### SUMMARY OF INVENTION

The present disclosure solves the above-mentioned needs by providing a beverage dispensing system, wherein information about the system is automatically collected, processed, and displayed in one or more beverage font lenses of a bar. The presently disclosed digital beverage font lens may be used in a wide range of beverage dispensing systems, from small ones comprising only one beverage container to large dispensing systems comprising many beverage containers. For larger dispensing systems, it is of particular relevance to keep track of the data of the system, e.g. the type of beverage contained in each beverage container, and the time at which each beverage container was installed to ensure the freshness of the beverage. In order to collect data of the system, one or more sensors are preferably provided, e.g. at least one pressure sensor for each beverage line or for each pressure chamber of the beverage dispensing system. Each of said pressure sensors may be configured to provide information on the remaining volume of the beverage container enclosed in a pressure chamber as described in PCT/EP2020/053640 (filed 12 Feb. 2020) entitled “Monitoring of a beverage dispensing system” by the same applicant. Remaining beverage volume may also be measured using weight sensors or sensors measuring the flow rate in the beer line and the time the beer tap is open. Each time a new beverage container is installed in the system, it is preferably immediately identified using an RFID system as described in International patent application no. PCT/EP2020/076493 entitled “RFID-equipped pressure chamber for keg” filed on 23 Sep. 2020. The data from the RFID system and the pressure sensors and the weight sensors are preferably collected in one or more electronic devices, which may wirelessly transmit the data to a cloud-based database, wherein it may be processed or alternatively transmit directly to the micro controller in the digital beverage font lens, which then process the data. Preferably, one or more beverage font lenses at the bar may then be configured to automatically retrieve the processed data from the cloud-based database and display the information in one or more display panels. This application describes a beverage font lens with such functionality in greater detail. Hence, a number of different technologies contribute to a highly digitalised and intelligent beverage dispensing system as described herein and in other applications by the same applicant.

The present disclosure relates to a beverage font lens comprising two embedded display panels controlled by a microcontroller unit (MCU) and/or a microprocessor unit (MPU). In the present application, the term microcontroller unit can alternatively be a microprocessor unit or additionally comprise a microprocessor. The two display panels allow the provision of separate information to the two sides of the beverage font lens. In a front bar installation, where the beverage font is positioned on a bar situated between a customer and an operator, one side of a beverage font lens is viewable and specific to the operator and the other side of the beverage font lens is viewable and specific to the customer. This enables customer relevant information (e.g. the beverage type, the beverage brand, etc.) to be visible to a customer on the customer side of the beverage font, while operator relevant information (e.g. the keg status, cleaning alerts, etc.) is available to the bartender operating the beverage dispensing system from the bartender side of the font. The customer can be presented to customer relevant information in the form of one or more subsequent still pictures or in the form of moving pictures or videos. That will inform the customer about the different beverages and the moving pictures or videos can catch the attention of the customer so that the customer decides to buy this beverage instead of any other. The operator will all the time without interruption know the essential information about the beverage, like e.g. temperature of the beverage, alcohol percentage, potential allergens, remaining volume of each beverage container, number of days the container has been in operation, time until next cleaning interval etc. as mentioned above.

The two display panels of the beverage font lens will also be suitable when the beverage font having the beverage font lens is positioned on a surrounded bar that is surrounded by customers like when the bar has the shape of a circle or rectangle with the operator within the circle or rectangle. The side of the beverage font lens facing the operator will not be specific to the operator, since the side facing the operator will also be viewable by a customer on the opposite side of the bar. However, the benefits of the beverage font lens comprising the two opposite display panels will be available for the surrounded bar.

The presently disclosed beverage font lens is herein also referred to as a digital beverage font lens, since the font lens houses electronics such as one or more microcontroller units and two electronic display screens, also referred to as display panels. The microcontroller unit may preferably control each of the display panels individually via two interfaces. Alternatively, the beverage font lens may comprise multiple microcontroller units, such as two micro controller units, wherein each microcontroller unit is configured to control one display panel. As an example, the beverage font lens may comprise two microcontroller units, such that each of the two display panels are controlled individually by each of the microcontroller units. However, it is preferred that the two or more display panels are interfaced to a single microcontroller unit. The advantage of a single microcontroller unit controlling two or more display panels is that the power and heat consumption is reduced, and the space requirement in the beverage font lens is smaller.

In case the beer font is located or installed behind the bartender when facing the customer, e.g. against or on the back wall of the bar area, only one side of the lens is visible to both bartender and customer. In this type of installation, the same front facing display must be able to display both information valuable to the customer and the bartender. As default the display will display the customer information such as brand logo. In the event that something is wrong, e.g. the beverage container or keg connected to the specific beer font is empty or nearly empty information relevant to the bartender or operator may be displayed—e.g. “Tap is empty”. To provide relevant information to the operator during normal operation the wall-mounted display may change from costumer relevant information to operator relevant information in the event that beer or other liquid is being dispensed from the font tap. In this situation the bartender will stand in front of the display and it will not be visible to the customer.

One microprocessor unit of the microcontroller unit can control the display panel(s).

A pressure sensor or other device installed in the draught system is used to provide information about draught events to the cloud service. The registration of a draught event in the cloud can be used to trigger the change display from customer relevant to operator relevant information.

In odd shaped bars such as a circular installation the lens may be viewed from both sides by the customer. In this type of installation, the lens should preferably have displays on both sides and be able to display customer relevant information as default on both sides.

The beverage font lens preferably comprises a housing for accommodating the above-described electronics (i.e. the microcontroller unit and the two display panels). The electronics should preferably be configured to be powered by a low voltage DC power, which is often already available in the existing beverage font, to power the LED beverage lens which is to be replaced by the digital beverage lens of the invention. As an example, a low voltage DC power could be 3-15V. Illuminated beverage fonts typically requires a low DC power. Accordingly, the presently disclosed beverage font lens is easy to install by replacing the old beverage font and using the existing wires in the beverage font, such that the new digital beverage font lens constitutes a retrofit to the existing beverage font. The ability to use the electrical power provided by the existing wires in the beverage font represents a sustainable solution, wherein many components of the beverage font are re-used. Additionally, it provides a more cost-effective instalment of the beverage font lens. The microcontroller unit may further comprise a power converter for converting the input power to another power for powering the one or more display panels, or alternatively the microcontroller unit can be part of a printed circuit board, which comprises the power converter. If the power converter cannot supply enough power to the font lenses, power for the microcontroller unit can be supplied directly from the wires providing e.g. AC line voltage or through an AC to DC transformer or an AC to AC transformer that provides the necessary power. In any case, the existing wires can still be used and installing the beverage font lens will be very cost-effective. The beverage font lens can be powered by a battery and/or the wires. The beverage font lens can be powered by the wires only, without a battery. A battery will have to be charged regularly and will eventually have to be replaced.

Accordingly, the present disclosure relates to a beverage font lens comprising a housing accommodating a customer display panel embedded in the housing and visible through a first window; an operator display panel embedded in the housing and visible through a second window opposite the first window; and a microcontroller unit configured to display information on the customer display panel and the operator display panel.

The housing of the digital beverage font lens comprises a first rounded outer edge. In particular the housing can be drop-shaped or oval. An electronic unit such as a microcontroller unit typically is part of a printed circuit board (PCB) or can alternatively comprise a PCB. The PCB is preferably rectangular, but can have any desired shape, like e.g. rounded. To save space (a) display panel(s) can be situated directly on the PCB, or alternatively with a thin spacer between the PCB and the display panel. The spacer creates a space between the display panel(s) and the PCB, so that electronic components can be positioned on the PCB behind the display panel(s), which means that the PCB can be less space consuming. If the PCB is large enough, the display panel(s) can be positioned on the PCB without the spacer and with the electronic components situated on the PCB around the display panel(s).

If the display panel is essentially circular, a square or rectangular PCB should preferably be small enough to fit within the display circle and not protrude outside.

However, the display must be connected to the board and wires or, more likely, a flexible printed circuit (FPC) must be connected and due to the nature of the LCD design this connection will protrude outside the circular areas of the active area of the LCD. The drop-shaped housing, which means an essentially round housing with a tapered or pointed protrusion in one direction, can then be made just to cover the display panel and at the same time the connection to the PCB when the FPC protrudes in one direction outside display panel.

The advantage of the drop shaped housing, is that the housing essentially looks like conventional light source beverage font lenses (see FIG. 1), and therefore will blend in well, in a bar that uses both conventional beverage font lenses and the digital beverage font lenses of the current invention.

The display panels have their own driver circuitry that allow communication with the microcontroller. The circuitry is commonly designed for one specific communication standard.

In case of an active matrix liquid crystal display—TFT, LCD or OLED—the driver circuit enables communication to transistors at each pixel. The transistors are located inside the display panel. The panel consist of at least two substrates. In case of transmissive LCD the main substrates are transparent, commonly glass. An LCD display will be a cost-effective solution. An OLED display will not require a light source behind, since the OLED display is active, where each pixel in the OLED display is illuminating.

A display typically consists of two glass substrates. In order for the display driver circuit to electrically connect to the transistors located between the two substrates one substrate is commonly made larger than the other substrate and is extending in one direction. When the two substrates are assembled the enlarged area forms a contact area where a flexible printed circuit (FPC) can be mounted. The FPC (flexible printed circuit) carries the driver circuit and a contact area for communication to the microcontroller located on the main PCB.

The driver circuit may also be bonded directly to the substrate and FPC is primarily used for connection to the main board containing the micro controller.

If the LCD viewing area is perfectly square, the outline of the LCD panel is commonly rectangular because one of the substrates is extended to form the contact ledge. In case of a round LCD with a minimum outline dimension the contactable substrate is extended locally in one direction. That the housing forms a teardrop shape has the advantage of covering the extending contact area without interfering with the interaction between the customer and the operator displays, while the displays can be made to cover all of the customer side and/or the operator side of the housing/lens.

The beverage font lens may be mounted on a beverage font, which is part of a beverage dispensing system. The beverage font lens is preferably configured to be compatible with most existing beverage fonts and thereby compatible with most existing beverage dispensing systems. In particular, the digital beverage font lenses of the present invention are designed to re-use the electric power already in the font, without having to draw or pull additional wiring. However, to obtain full functionality of the digital beverage font lens, it should preferably be accompanied by a system for obtaining and processing data related to the beverage dispensing system. For a large beverage dispensing system, such a system will typically comprise a plurality of measuring devices and electronic devices in addition to the microcontroller units housed in the beverage font lens. A system for obtaining data of the beverage dispensing system, processing said data, and displaying said data and/or processed data in the beverage font lens is also disclosed herein. The beverage font lens is compatible with conventional beverage dispensing systems intended for professional or private use such as conventional steel keg systems, the DraughtMaster® system produced by the applicant company, or the bag in container systems such as Heineken Blade® or BeerTender® or Anheusher-Bush InBev PureDraught®. The DraughtMaster® system is described in e.g. WO 2019/158562, WO 2007/019848, WO 2007/019849, WO 2007/019850, WO 2007/019851 and WO 2007/019853. These applications are hereby incorporated by reference in their entirety. The DraughtMaster® system utilizes collapsible beverage containers, each beverage container placed in a pressure chamber. Such a system further comprises a pressure source such as an air compressor. When dispensing the beverage, compressed air is allowed to enter the pressure chamber, thereby causing the beverage container to collapse while dispensing the beverage. The bag in container systems also require a pressure source, here the pressure chamber is however the outer wall of the keg (container), in that the pressure is applied to the space between the outer container and the beverage containing bag/container inside the outer container to drive the beverage out of the inner container.

Preferably, the system for obtaining and processing data related to the beverage dispensing system is a wireless system so that the only wired connection is the electric power already in the font. That will make installation of the lens according to the present invention very easy and cost-effective.

A lens that is communicating wirelessly with the system for obtaining and processing data related to the beverage dispensing system will not necessarily know initially with which sensors of the system to communicate. To connect a lens that has recently been installed, the system may comprise a software application preferably presenting all sensors of the system, where the sensors with which the recently installed lens will communicate can be selected and connected to the lens. Provisioning the lens can be achieved by selecting the relevant sensors and by reading a code like a graphic code like e.g. a barcode, a 2D barcode, or a QR code representing the lens. The graphic code can be presented on the housing of the lens e.g. on a sticker or the graphic code can be an electronic graphic code presented on the screen of the lens. The electronic graphic code can be electronically stored in the lens and presented on the screen of the lens when activated e.g. by pressing a button or the screen of the lens if the screen preferably the screen turning to the operator is or comprises a touchscreen.

In order to manage and keep track of the beverage containers, the containers may be equipped with radio-frequency identification (RFID) tags, such as near-field communication (NFC) tags. Besides having a unique identification, the system may extract information about the beverage, such as the type of beverage, the brand of the beverage, the initial volume of the container, the date and/or origin of production, the alcohol percentage and allergens if applicable, etc. Such information may be provided directly by the RFID tag. Preferably, each beverage container is provided with an RFID tag and the beverage dispensing system is preferably configured to read the RFID tag. In case of the DraughtMaster® system, this may be achieved by providing each pressure chamber with an annular antenna configured to read the RFID tag on the beverage container installed in said pressure chamber. Such a solution is described in a pending International patent application entitled “RFID-equipped pressure chamber for keg” filed on 23 Sep. 2020 (application no.: PCT/EP2020/076493), which is hereby incorporated by reference in its entirety. When a person, e.g. the bartender or the bar staff, changes the beverage container (e.g. when it is empty) and installs a new beverage container, the beverage dispensing system recognizes the change of beverage container, for example through the drop of pressure to atmospheric pressure in the pressure chamber as a result of opening of the chamber to replace the container. Preferably, the system instantly recognizes the new beverage container via the RFID tag on the beverage container. Information, such as the brand of the beverage, may then be automatically transmitted to the beverage font lens.

The beverage font lens is preferably configured to receive and display data, such as the data provided by the RFID tag. The data may be processed before it is transmitted to the microcontroller in the font lens. In one embodiment of the presently disclosed system, an electronic device is provided for each pressure chamber said electronic device being configured for reading the RFID tag on the beverage container in the corresponding pressure chamber. In the case where the pressure chamber is the outer container of a bag in a beverage container or keg the electronic device may be connected to the unit which couples the beverage container or keg to the dispensing line. The electronic device may then process data received by the RFID tag or it may transmit the raw data e.g. to a cloud server. The electronic device is preferably configured to transmit the data to a cloud server, which may store and/or further process the data. In one embodiment, the data provided by the RFID tag can be a serial number. When the serial number is transmitted to a cloud server, the cloud server can e.g. return information about the brand of the beverage, type of beverage, and/or the total amount of beverage in the beverage container when full, etc. Alternatively, the electronic device may transmit the data directly to the microcontroller unit embedded in the beverage font lens. The advantage of the combination of an RFID system as described above and a digital beverage font lens is that once a beverage container is replaced, the system automatically and uniquely identifies the beverage container and transmits relevant information such as the brand to the customer side of the digital beverage font lens.

All communication to the lens preferably is through the cloud service.

In the event that the content of a newly inserted beverage container differs from the previous liquid the cloud service can push information to the operator display warning the operator that the liquid has been changed. In some cases, the warning can be accommodated with direction to empty the liquid standing the beer line before serving to a customer. This is typically done by disposing of a few draughts. The system should know the length of each beer line in the installation and be able to recommend the correct amount of liquid to be disposed of. Guiding the operator to empty the line may be especially valuable if the two liquids are alcoholic and non-alcoholic or beer and cider. It may also display warnings that the new liquid contains substances that are known to cause allergic reaction to some people. It may keep displaying a warning if the previous liquid contained such substance.

If a brand is actively promoting a new recipe this may also be displayed on the operator display if the replaced beverage container contained the obsolete recipe.

Additionally, the electronic devices and the microcontroller units are preferably linked to the cloud, such that the system may be updated remotely. Preferably, the information provided in the customer display panel may be exchanged and/or updated centrally and remotely, since each digital beverage font lens is wirelessly connected to the cloud. This enables a direct and instant change of e.g. the displayed beverage brand in the beverage font lens. As an example, some types of beverage are associated with particular seasons or holidays during the year. The presently disclosed digital beverage font lens allows a bar owner, or the brand owner, to instantly update the displayed brand in the font lens e.g. to fit a current event or a particular season. Examples of events could be sport events such as football games, etc. The presently disclosed beverage font lens preferably allows dynamic content to be displayed in the customer side of the font lens. This provides endless possibilities of instant branding, e.g. by displaying text messages, logos, images, movies, etc. in the customer display panel. For instance, when the home country scores a goal in an international football game, the customer display could display the flag of the country or bring a message such as “GOAL”, etc. Perhaps, a video replay of the goal may even be displayed in the font lens. In case of multiple beverage font lenses, e.g. installed on the same beverage font, the beverage font lenses may further be configured to collectively display information across the individual beverage font lenses. An example is provided in FIG. 3a, wherein the three beverage font lenses collectively provide the message “Happy Hour @ 17”. Accordingly, the presently disclosed beverage font lens, and accompanying electronic system for processing data, facilitates dynamic content to be displayed both at the customer side of the bar and the operator side of the bar.

The present disclosure further relates to a beverage dispensing system for dispensing a beverage, said beverage dispensing system comprising: one or more beverage containers for accommodating a beverage, wherein the beverage container(s) comprise(s) a beverage outlet, a pressure source configured to expel the beverage out of the beverage container(s) through the beverage outlet, a beverage font comprising one or more tapping heads for extracting the beverage from the beverage container(s), a tapping line extending from said beverage outlet to said beverage font, said tapping line comprising one or more beverage lines, and a beverage font lens as disclosed herein.

In an embodiment, the beverage font lens can be electrically connected by wire to a power source, as the only wiring needed. All other communication can be done wirelessly. The advantage is that the exchange of the old LED powered lens for the beverage font lens of the present disclosure can easily be done without the need to pull new conductors for the new beverage font lens of the present disclosure, since the only wires for the old LED powered lens are the two wires for providing electrical power. Installing the new beverage font lens is very easy and cost effective.

All embodiments of the beverage font lens presented in this application can alternatively have one screen. A beverage font lens with one single screen on one side of the beverage font lens will be suitable in a back bar installation, where the beverage font is not installed on a bar between the customer and the operator, but on a bar at a wall on the opposite side of the operator. In the back bar installation, the customer and the operator will see the same side of the beverage font lens, and only one screen or display unit will be necessary. The screen will preferably present information to the operator about the keg. However, the screen could also show in one mode the brand and type of the beverage to the customer between the occasions when the beverage is served, and switch to another mode, where the screen can present the information to the operator when the beverage font lens is activated, e.g. by touching the tap handle, or by touching the screen if the screen is a touchscreen, or by using pressure sensor in pressure chamber or any type of flow sensor to detect tap open and tap closed events.

The beverage font lens according to the present disclosure will be suitable to be positioned such that it is visible both from the customer side and the bartender side, e.g. on a beverage font and/or on top of the tap handle. Preferably, the beverage font lens is positioned on the beverage font, such as on top of the beverage font, and not on the tap handle. In this way the beverage font lens is always visible to the customer, even when operating the tap handle. The beverage font lens according to the present disclosure can preferably be positioned in a fixed position relative to the beverage font, so that the beverage font lens cannot be move in relation to the beverage font, so that the beverage font lens is always visible to the customer, even when the tap handle is operated.

The present invention also relates to a beverage font comprising the beverage font lens, wherein the beverage font lens is fixedly connected to the beverage font is fixedly connected to the beverage font, or connected to the beverage font but not on a tapping handle.

That the beverage font lens is fixedly connected to the beverage font or is connected to the beverage font not on a tapping handle means that the beverage font lens cannot be bent in relation the beverage font. The information on both display panels can be seen at all times. When beverage is served by activating the tapping handle, the information presented on the display panel facing the operator will still be visible to the operator. If the operator during dispensing beverage suddenly wants to check any information provided on the display panel facing the operator, the operator does not need to deactivate the tapping handle to be able to read the display panel; the information is available also during beverage dispensing.

### DESCRIPTION OF DRAWINGS

FIG. 1A shows a front view of the drop-shaped beverage font lens according to an embodiment of the present disclosure.

FIG. 1B shows a top view of the beverage font lens of FIG. 1A.

FIG. 1C shows a side view of the beverage font lens of FIG. 1A.

FIG. 1D shows a bottom view of the beverage font lens of FIG. 1A.

FIG. 2 shows in 3D perspective the beverage font lens of FIGS. 1A-1D.

FIG. 3a shows the beverage font lens when mounted on a beverage font, which is typically part of a beverage dispensing system.

FIG. 3b shows the customer side and the operator side of the beverage font lens, respectively.

FIG. 4a shows a beverage font lens that can present operator information about any of the beverage dispensing system connected to each of the three beverage fonts.

FIGS. 4b-4d show two substrates controlled by an FPC for a display panel, particularly for a customer display panel.

FIG. 4e shows an exploded view of the beverage font lens.

FIG. 5 shows the data flow in a system for displaying data of a beverage dispensing system. The system is furthermore capable of obtaining data of the beverage dispensing system, processing the data, and displaying the data.

FIG. 6 shows the data flow in a system for displaying data of a beverage dispensing system. The system is similar to that of FIG. 5, except that this embodiment specifies examples of measuring devices and display panels.

FIG. 7 shows a part of the system for obtaining, processing, and displaying data in the beverage font lenses of a beverage dispensing system. This embodiment shows three electronic devices, one for each beverage font lens.

FIG. 8 shows a beverage dispensing system. Typically, at least one beverage font lens is provided for each type of beverage.

### DETAILED DESCRIPTION OF THE INVENTION

The present disclosure relates to a beverage font lens for a beverage dispensing system.

### Housing

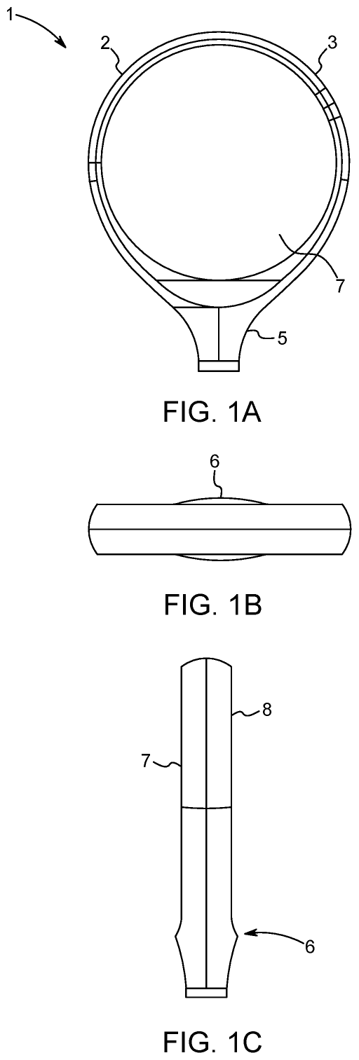

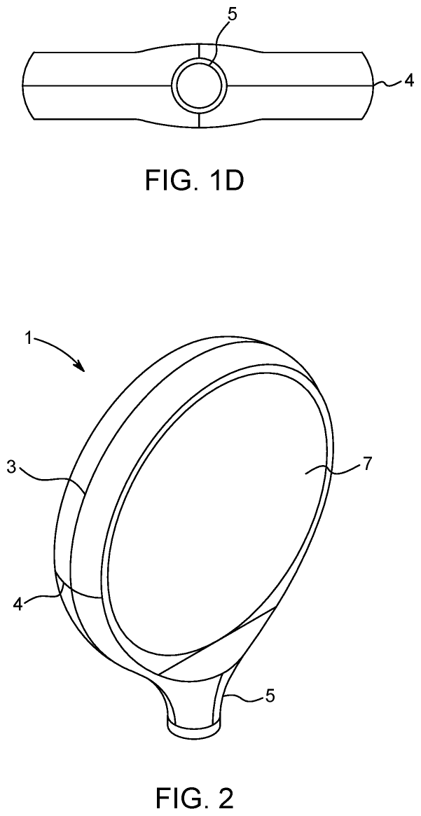

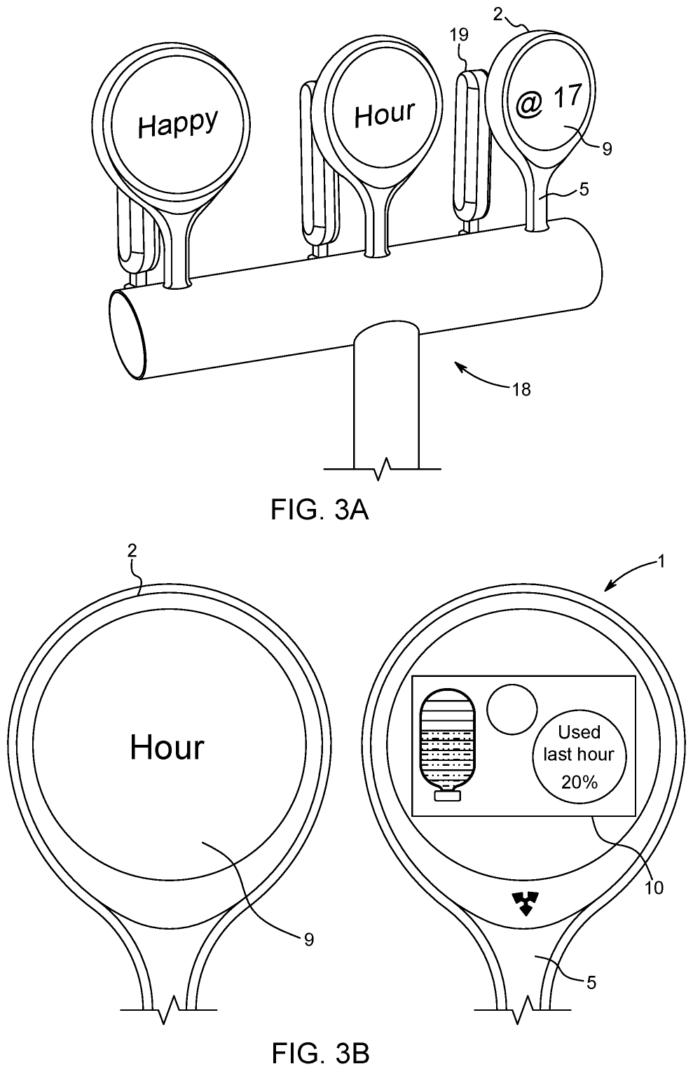

The beverage font lens 1 comprises a housing 2 for accommodating one or more electronic displays 9,10 and a microcontroller unit 16 for controlling said displays. The housing preferably comprises a stem 5 for supporting the beverage font lens and for keeping the font lens upright, when it is mounted on a beverage font 18 (cf. FIG. 3a). The stem 5 may have any suitable shape for this purpose. One embodiment of the beverage font lens 1 comprises a stem 5 with a circular cross-section (cf. FIG. 1D), the cross-section being wider towards the top of the stem compared to the bottom of the stem. In this embodiment, the stem 5 and the housing 2 are integrated as one unit. The housing preferably further comprises a first window 7 and a second window 8 positioned opposite said first window. When the beverage font lens is installed on a beverage font, the first window is oriented towards the customer side of the bar, whereas the second window is oriented towards the operator/bartender side of the bar. The first and second windows are preferably circular, and the housing preferably conforms to the shape of the windows in at least a part of the housing. In a preferred embodiment of the beverage font lens, the housing comprises a rounded top section that conforms to a first rounded edge 3 of the first and second windows and a rounded bottom section that expands slightly, thereby creating a drop-shape when facing the first and/or the second window (cf. FIG. 1A and/or FIG. 3b). The first and/or the second window may comprise a material that is transparent to the radio-frequencies commonly used in Radio-frequency identification (RFID) systems and/or Near-field communication (NFC) and/or to the frequency range(s) used for WiFi and/or for Bluetooth, as well. In one embodiment, the second window comprises a plastic that is transparent to radio-frequencies of typical RFID systems, and/or Near-field communication (NFC), and/or to the frequency range(s) typically used for WiFi and/or for Bluetooth. The first and/or the second window may also be a frame surrounding an opening without any material.

The second window 8 facing the operator can be made a little smaller than the first window 7, where the material around the second window can be of a material like e.g. plastic that is transparent to the radio-frequencies commonly used in Radio-frequency identification (RFID) systems and/or Near-field communication (NFC) and/or to the frequency range(s) typically used for WiFi and/or for Bluetooth.

Advantageously, the drop-shaped or oval shaped part of the housing 2 can comprise a material like e.g. plastic that is transparent to the radio-frequencies commonly used in Radio-frequency identification (RFID) systems and/or Near-field communication (NFC) and/or to the frequency range(s) typically used for WiFi and/or for Bluetooth. It may be difficult and/or costly to design the display panels to be transparent to the radio-frequencies. Instead, the housing can be made with a drop-shaped or oval shaped part, where at least the drop-shaped or oval shaped part of the housing is transparent to the radio-frequencies so that the RF-signal can reach the microcontroller within the housing and the housing can still be made small without interfering the interaction between the customer and the operator, while the displays can be made to cover all of the client side and/or the operator side of the housing/lens.

### Display Panels

Preferably, the housing 2 is configured to accommodate at least two display panels: a customer display panel 9 embedded in the housing 2 and visible through the first window 7; and an operator display panel 10 embedded in the housing and visible through the second window 8. The display panels may be any type of electronic displays such as light-emitting diode (LED) displays, liquid-crystal display (LCD) displays, thin-film-transistor liquid-crystal displays (TFT LCD), or other technologies based on LCD such as in-plane switching (IPS), or e-ink and other bi-stable display technologies. Preferably, the display panels are flat-panel displays. In one embodiment, the customer display panel 9 and/or the operator display panel 10 is/are (a) TFT LCD display(s). Furthermore, the customer display panel and/or the operator display panel may constitute a touchscreen or comprise a touchscreen. In one embodiment, the operator display panel comprises a capacitive touchscreen. In one embodiment, the customer display panel is circular and the operator display panel is rectangular. In another embodiment, both the customer display panel and the operator display panel are circular. In an embodiment, both the customer display panel and the operator display panel are rectangular.

The display panels may have any suitable size as long as they can be embedded in the housing 2 of the beverage font lens 1. The customer display panel 9 may preferably have a display size similar to the size used for conventional beverage lenses, this may vary across regions and change with changing trends. Examples of customer display panel sizes are 2-5 inches, or more preferably 3-4 inches. The operator display panel may be a bit smaller than the customer display panel, such as 2-4 inches or 2-3 inches. The display size is measured along the diagonal of the display in accordance with common ways of reporting display sizes. The resolution of the display panels may be any resolution. In a preferred embodiment, the customer display panel has a higher resolution than the operator display panel. This is because the customer display panel should be configured to display image(s) or video(s), preferably of a high resolution, whereas the operator display panel is configured to display information (e.g. in the form of text(s), logo(s), or low-res image(s)) to the bartender. As an example, the customer display panel may have a resolution of 800×800 RGB (800×800 pixels with the RGB colour model), and the operator display panel may have a resolution of 240×320 RGB. Other resolutions are of course possible within the scope of the present disclosure. The lower resolution of the operator display panel than the resolution of the customer display panel means that the beverage font lens can be made more cost-effective and more power-effective (less power consumption), and still provide display panels fulfilling the demands of both the customer and the operator. The lower resolution of the operator display panel than the resolution of the customer display panel also means that the microcontroller unit 16 for controlling the two displays will be more cost-effective than a microcontroller unit for controlling two displays with high resolution. The customer display panel is preferably configured to be connected to the first interface of the microcontroller unit 16. Accordingly, the customer display panel 9 preferably has a frame rate of at least 20 frames per second (FPS), more preferably at least 24 FPS, even more preferably at least 30 FPS. The operator display panel 10 is preferably configured to be connected to the second interface of the microcontroller unit. Accordingly, the operator display panel preferably has a frame rate of at most 20 FPS, more preferably at most 15 FPS, even more preferably at most 10 FPS. Such a difference in frame rates between the customer display panel and the operator display panel will be cost-effective and still provide display panels fulfilling the demands of both the customer and the operator.

In addition to specific MIPI DSI high bandwidth display interfaces developed specifically for small displays found in mobile phones and wearables, many low-cost microcontrollers support multiple connectivity interfaces including Serial Peripheral Interface (SPI) that is useful for low resolution LCD's. It is possible to drive two displays with most microcontroller units (MCU's) if resolution and frame rate of one display is suitable for SPI with maximum 10 MB/sec. The MCU can have two interfaces like e.g. an MI PI DSI high bandwidth display interface and a SPI, where e.g. the frame rate of the DSI is 30 FPS and the frame rate of the SPI is 10 FPS.

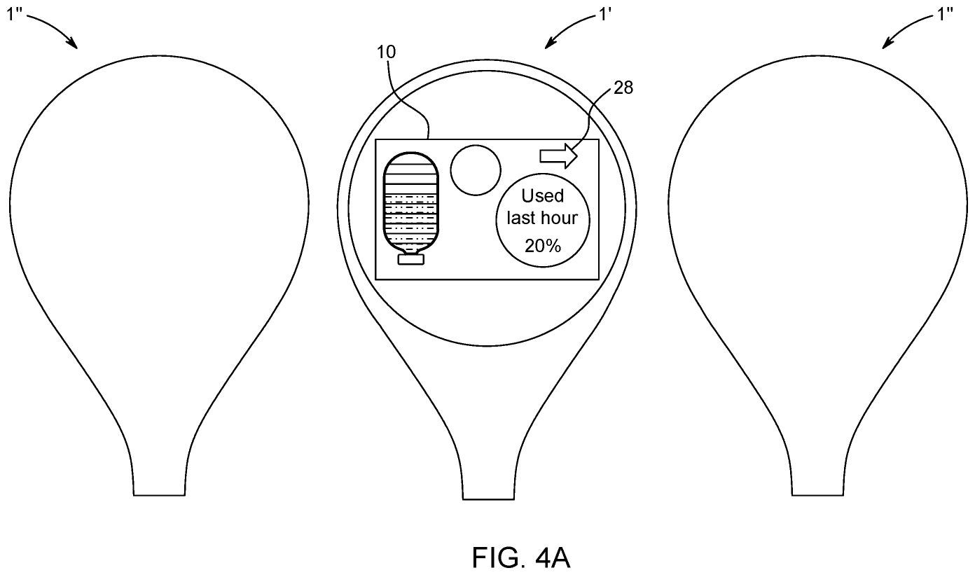

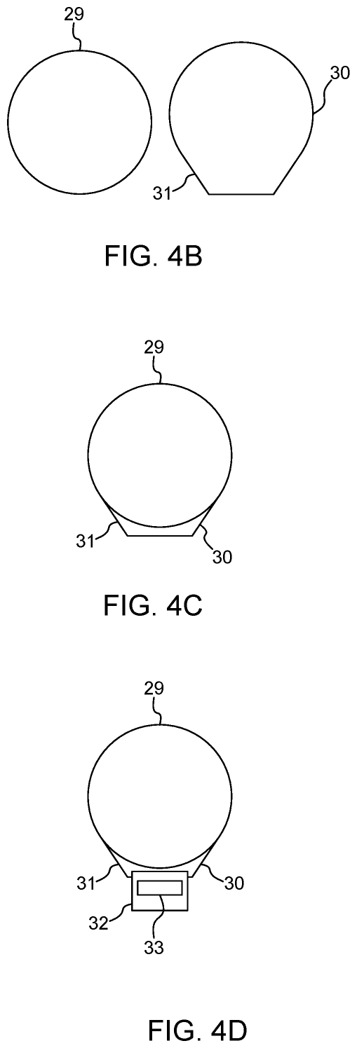

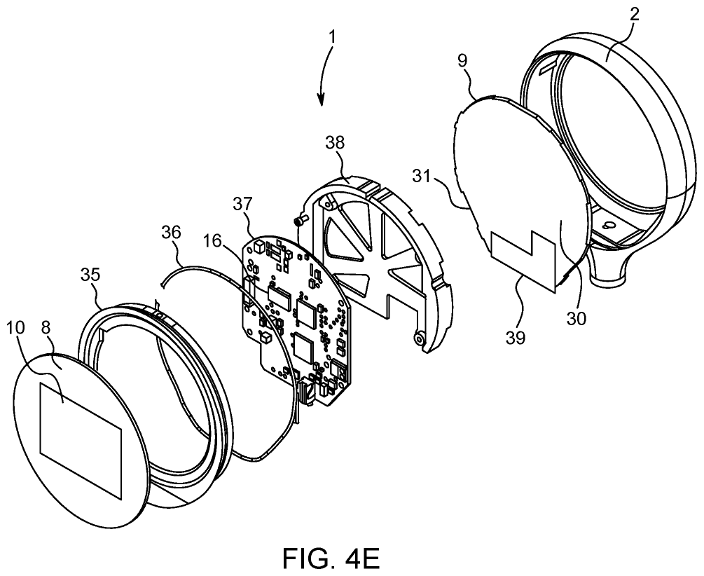

In general, the display panels do not need to have a similar shape as the windows. As an example, the operator display panel may be rectangular as seen in FIG. 3b, which has a lower cost than round panels. In addition, rectangular displays come in a wide range of sizes and resolutions suitable for SPI interface. Additionally, electronic displays often comprise a back-section with electrical connections for controlling the display. In order to access such electrical connections for controlling the one or more displays, especially a round customer display panel, embedded in the housing, the electrical connections may have a protrusion 31 below the displays inside the housing. Therefore, the shape of the housing 2 is preferably not perfectly circular, but rather it expands near the stem 5 of the housing, such that the electrical connections are accessible below each display inside the housing. In one embodiment, the housing of the digital beverage lens is oval or droplet shaped. The tapered end of the oval or droplet shape provide space to accommodate the protrusion 31 extending downward from the second substrate 30, where the protrusion comprises the electrical connections for the customer display panel 9 and the operator display panel 10 and possibly also the MCU and/or the MPU of the PCB, where the protrusion extends below the display panels, as illustrated in FIGS. 4b, 4c, 4d and 4e.

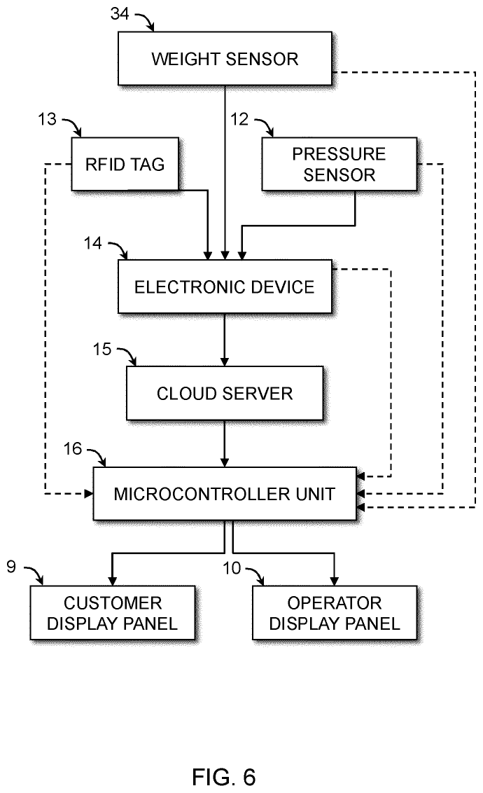

Preferably, the customer display panel 9 is configured to display information relevant to a customer being served e.g. at a bar. The information presented in the customer display panel is also referred to herein as customer information. In general, the customer information may comprise any information such as the brand of the beverage(s) contained in the beverage container(s), advertisements, messages, symbols, images, videos, or combinations thereof. Some of this information may be provided by an information system configured to monitor the beverage dispensing system, as described in more detail elsewhere in this application. As an example, the brand of the beverage may be provided by an RFID tag 13 and shown in the customer display panel 9 as schematically shown in FIG. 6. The customer information may be configured to be updated manually and/or automatically from a computing device wirelessly connected to the beverage font lens 1 and/or from a remote server, which can be a cloud server 15.

Preferably, the operator display panel 10 is configured to display information relevant to a person operating the beverage font 18, e.g. a bartender operating the beverage font behind a bar counter. The information presented in the operator display panel is also referred to herein as operator information. The operator information comprise any of the following content: the remaining volume of beverage in the beverage container(s), the type of beverage in the beverage container(s), when a beverage container is connected/disconnected to the beverage font, cleaning alerts, the dispensed volume of beverage from the beverage container(s) throughout a given time interval, combinations thereof, or other information relevant to the bartender. Preferably, the operator information is updated automatically and continuously in real-time to reflect a current status of the beverage dispensing system.

In an embodiment, the operator display panel 10 can be configured to display the operator information of two, three or more beverage containers. The beverage font lens having two display panels is more expensive than a beverage font lens having only one display panel. That one display panel displays the operator information of at least two beverage containers will save costs. Another advantage is that the information can be found at one place. An arrow 28 or alternative direction indicator on the display panel pointing at a beverage font will indicate to which beverage font and the corresponding beverage container the operator information relates to. One display panel displaying the operator information of three beverage containers will be ideal, since that will be more cost-effective than displaying the operator information of two beverage containers, and since the operator can easily understand, at which beverage font the arrow is pointing, an arrow pointing downward for the beverage font, on which the beverage font lens is situated, an arrow to the right for the beverage font to the right of the beverage font, on which the beverage font lens is situated, and an arrow to the left for the beverage font to the left of the beverage font, on which the beverage font lens is situated. Other means than an arrow can be used to show, to which beverage font and beverage container the operator information relates.

### Microcontroller Unit

The housing 2 can be configured to accommodate a microcontroller unit 16 for controlling the customer display panel 9 and the operator display panel 10, as well as the touch screen on the operator display, wherein the touch screen can run on yet another interface—I²C (the Inter-Integrated Circuit bus). The microcontroller unit preferably comprises a first interface and a second interface, each of said interfaces configured to connect an electronic display to the microcontroller unit. The first interface is configured to support high-speed image data, preferably with a frame rate of at least 20 FPS (frames per second), more preferably at least 24 FPS, even more preferably at least 30 FPS. The second interface is configured to support low-speed image data, preferably with a frame rate of at most 20 FPS, more preferably at most 15 FPS, even more preferably at most 10 FPS. Such a microcontroller unit will be very cost-effective and still provide an interface for controlling a high-resolution display for the customer and another interface for controlling a display for the operator that can provide the necessary information for the operator. In one embodiment of the presently disclosed beverage font lens, the customer display panel is configured to connect to the microcontroller unit through the first interface, and the operator display panel is configured to connect to the microcontroller unit through the second interface. In one embodiment of the microcontroller unit, it may be powered by 5V DC, or a similar low DC voltage. The microcontroller unit 16 may further comprise a power converter for converting the input power to another power for powering the one or more display panels, or alternatively the microcontroller unit can be part of a printed circuit board, which comprises the power converter.

The microcontroller unit 16 may be configured for wireless transmission of data or may be connected to a radio-frequency (RF) module for wireless transmission of data. The RF module can be a chip with an RF transmitter and/or an RF receiver. Said wireless transmission being enabled by any available wireless technology, such as Bluetooth, Bluetooth Low Energy (BLE), Ultra Wideband (UWB), Wi-Fi, IEEE 802.11ah (Wi-Fi HaLow), GSM, 4G, or 5G. The microcontroller unit can also preferably be configured for wirelessly receiving and/or transmitting information related to the beverage dispensing system or may be connected to a RF module (e.g. wiredly connected) for wireless transmission of information related to the beverage dispensing system. As an example, the microcontroller unit or the second microcontroller unit (if there is a second microcontroller, the microcontroller unit and the second microcontroller unit each control one of the two display panels) or another chip may receive information from one or more electronic devices 14 that receive and process data obtained from one or more beverage containers and/or from one or more pressure chambers housing said beverage containers or from tapping lines connected to said beverage containers. Each electronic device may be configured to receive data from one or more measuring devices configured for monitoring the beverage dispensing system. The microcontroller unit, the second microcontroller unit, and/or the other chip may additionally or alternatively be configured for wirelessly receiving information related to the beverage dispensing system from a cloud server 15.

### Beverage Dispensing System

The present disclosure further relates to a beverage dispensing system 17 for dispensing a beverage. One embodiment of the beverage dispensing system comprises one or more pressure chambers comprising a connectable base part 23 and lid part 24 defining a sealed inner space for accommodating and encapsulating a collapsible beverage container 25 having a beverage outlet connectable to a coupler part placed in the base part or lid part of the pressure chamber, a beverage font 18 comprising one or more tapping heads 20 for extracting the beverage from the collapsible beverage container(s), a tapping line 21 extending from said coupler part(s) to said beverage font, said tapping line comprising one or more beverage lines 22, and a beverage font lens 1 mounted on said beverage font 18 or the tap handle 19.

The beverage dispensing system 17 may further comprise at least one measuring device 11 for each pressure chamber configured for monitoring at least one property of the corresponding tapping line 21, sealed inner space, base part 23, lid part 24 and/or collapsible beverage container 24. Such a beverage dispensing system is further described in international patent application no. PCT/EP2020/053640 (filed 12 Feb. 2020) entitled “Monitoring of a beverage dispensing system” by the same applicant as for this application and hereby incorporated by reference.

Alternative beverage dispensing systems are the bag in container systems, as well as conventional steel keg systems.

### Measuring Devices

The beverage dispensing system 17 may comprise one or more measuring devices 11, e.g. in the form of sensors, for monitoring various properties of the beverage dispensing system. The measuring device(s) can for be configured for monitoring / measuring at least one physical quantity or property of the sealed inner space of the pressure chamber, a property such as temperature, pressure, humidity, sound, etc. The measuring device(s) can also be configured for monitoring at least one property and/or a physical quantity of the tapping line 21, the beverage line 22 and/or the collapsible beverage container 25, e.g. pressure, sound, force, acceleration, weight, etc. A physical quantity should be understood as a property of a material or system that can be quantified by measurement. A physical quantity may relate to the property of a gas, e.g. the pressure of a gas.

When employing electronic and network connectable sensors/measuring devices, the data generated needs to be managed. Data can either be processed and/or stored locally, but it is also an option to process and/or store data centrally, e.g. in a cloud server 15, if the electronic devices and/or the measuring devices is network/internet connectable. This further provides the option of a third party getting access to the generated data, i.e. such that the supplier(s) of beverage to the beverage dispensing system also can monitor and survey the beverage dispensing system.

The measuring devices 11 may comprise one or more pressure sensors 12, temperature sensors, weight sensors 34, flow sensors, audio sensors or other sensors. As an example, the beverage dispensing system may comprise a pressure sensor 12 for monitoring a pressure value, and/or a change in pressure, in the sealed inner space or in the tapping line 21. A change in pressure in the sealed inner space or in the tapping line can be the result of several actions and/or events in the system. It can be the activation and de-activation of a tap handle 19 in contact with the corresponding beverage container, or it can be a compressor that activates in order to build up the pressure inside the sealed inner space, or it can be the change of a beverage container.

In another example, the beverage dispensing system may comprise a weight sensor 34 in addition to or instead of the pressure sensor 12 for monitoring a weight value, and/or a change in weight, of the beverage in the beverage container (normally the beverage container with the beverage is weighed and the pre-weighed weight of the empty beverage container is withdrawn). A change in weight of the beverage will be due to beverage being tapped from the beverage container e.g. through a font.

Hence, a pressure sensor 12 configured to monitor the pressure inside the sealed inner space and/or a weight sensor 34 configured to monitor the weight of the beverage may be used to determine certain events such as the activation of a tap handle in the beverage dispensing system. Such determinations can be used to estimate the remaining volume in the beverage container, the dispensed volume from the container, or combinations thereof. Systems and methods for determining these events and corresponding values are further described in PCT/EP2020/053640 (filed 12 Feb. 2020) entitled “Monitoring of a beverage dispensing system” by the same applicant, which is hereby incorporated herein in its entirety.

### Electronic Devices

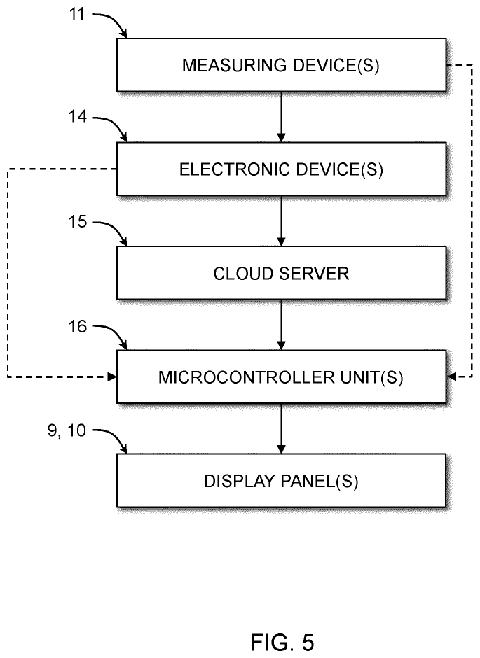

Preferably, the beverage dispensing system 17 as described above further comprises one or more electronic devices 14 configured to receive data from the one or more measuring devices 11. Preferably, the beverage dispensing system comprises one of such electronic devices for each pressure chamber or for each beverage container of the system, wherein each of said electronic devices are configured to wirelessly communicate with the one or more measuring devices monitoring the beverage dispensing system. As an example, the electronic devices may be configured to process pressure data received from one or more pressure sensors. The electronic devices may be configured e.g. by comprising software with an appropriate algorithm for determining the volume of a dispensed beverage and/or the remaining volume in the corresponding beverage container, wherein said determination is based on the measured pressure in the sealed inner space and/or in the tapping line of the beverage dispensing system. Preferably, each electronic device is configured to receive and/or transmit data wirelessly to a cloud server as illustrated in FIGS. 5-7. The cloud server 15 is preferably configured to store and/or process the data received from the electronic devices. Furthermore, the microcontroller unit(s) 16 are preferably configured to retrieve the data from the cloud server in order to present visual information based on said data, said visual information being presented in the display panels 9,10 of the beverage font lens 1. Alternatively or additionally, each electronic device 14 may wirelessly transmit data directly to a microcontroller unit 16 embedded in the beverage font lens 1 as indicated by the dashed arrow in FIG. 5.

Preferably, each of the one or more electronic devices 14 are configured to automatically identify information related to the contents of the one or more beverage container(s). This information may comprise any of the following information: the type of beverage, the brand of the beverage, the sub brand of the beverage, the date of the batch of the beverage, the ‘best before’ date, the Stock Keeping Unit (SKU) number, the European Article Number (EAN), or other relevant information related to the beverage contents, such as alcohol percentage and allergens. The automatic identification is preferably achieved using a radio-frequency identification (RFID) system. Accordingly, each beverage container may comprise an RFID tag 13, which is readable by the one or more electronic devices 14. Consequently, each electronic device may comprise an RFID reader configured to read the RFID tag of the corresponding beverage container. Such an RFID system for a beverage dispensing system is further described in the International patent application PCT/EP2020/076493 entitled “RFID-equipped pressure chamber for keg” filed on 23 Sep. 2020 by the same applicant.

Accordingly, the present disclosure further relates to a system for obtaining and processing data related to the beverage dispensing system. Such a system may also be referred to herein as an information system. A suitable information system comprises one or more measuring devices 11, one or more electronic devices 14, at least one cloud server 15 suitable for cloud computing, and one or more microcontroller units 16, all of said devices and units being explained in more detail elsewhere in the present disclosure. Such a system is illustrated in FIG. 5. A preferred embodiment of such an information system comprises one electronic device 14 per beverage container 25 of the beverage dispensing system, one cloud server 15, and one microcontroller unit 16 per beverage font lens 1. In the preferred embodiment, each electronic device is configured to receive data from a measuring device monitoring a property of a specific pressure chamber, and/or a specific part related to said pressure chamber, e.g. the specific beverage container enclosed in the pressure chamber or the specific tapping line extending from said beverage container.

Hence, in a beverage dispensing system 17 comprising three pressure chambers, each pressure chamber accommodating a collapsible beverage container 25, a suitable information system for monitoring the beverage dispensing system will preferably comprise at least three measuring devices 11, e.g. three pressure sensors 12, each monitoring the pressure in the sealed inner space of each pressure chamber. The information system will preferably further comprise electronic devices 14, one associated with each pressure chamber, such that each electronic device is configured to receive data from the corresponding measuring device (e.g. receive pressure data from the pressure sensor). In the preferred embodiment of the information system, each electronic device is configured to process the data received from the measuring device, e.g. the electronic device is configured to process pressure data to infer other information of the beverage dispensing system as further described in PCT/EP2020/053640 by the same applicant. An example would be for the electronic device to determine the dispensed volume of beverage from a beverage container based on the obtained pressure data. Subsequently, each electronic device is preferably configured to transmit the processed data, and/or raw data received from the measuring devices to a cloud server, which may store the data and/or further process the data. The data stored in the cloud server may then be transmitted to the microcontroller unit of each beverage font lens, which may further display the data, or graphics based on the data, in the customer display panel and/or the operator display panel. Typically, information such as the brand of the beverage may be displayed in the customer display panel 9 (said information may be provided by the RFID tag 13 on the beverage container 25), whereas information such as the remaining volume of the beverage container may be displayed in the operator display panel 10. This is illustrated in FIG. 3b.

### Beverage Font Lens with a Single Panel

A beverage font lens can comprise a housing accommodating a single panel embedded in the housing and visible through a window. Such a beverage font lens will be suitable to be placed at a wall, where an operator and a customer is able to see the same display panel. The housing can also accommodate a microcontroller unit configured to display information on the single display panel, wherein microcontroller unit can be configured in a standard mode to display customer relevant information, such as brand logo, on the single display panel, and in an activated mood to display operator relevant information related to a beverage dispensing system. Most of the time, the beverage font lens will be in the standard mode, where customer relevant information like the brand of the beverage served at that font, like advertisement, or like anything else that can be of interest for a customer, is displayed.

Regarding the beverage font lens with the single panel, the microcontroller unit can be configured to change from the standard mode to the activated mode, when a sensor wiredly or wirelessly connected to the microcontroller detects that beverage container is empty or nearly (below a predetermined ratio of the full beverage container) empty, the beverage dispensing system needs to be cleaned, an operator pour beverage from the beverage dispensing system, the panel is touched, a button wiredly or wirelessly connected to the microcontroller and preferably positioned on the beverage font lens is pressed, a motion sensor wiredly or wirelessly connected to the microcontroller and preferably comprised by the beverage font lens senses motion of a person nearby, or a proximity sensor, like a capacitive sensor or an IR sensor, wiredly or wirelessly connected to the microcontroller and preferably comprised by the beverage font lens senses. In this way, the beverage font lens changes from showing customer relevant information to operator information easily, fast and without using much of the operators time.

The beverage font lens with the single panel as described above can comprise any combination of features presented in this application regarding the beverage font lens with two display panels, except that there is one single panel.

The beverage dispensing system as presented in this application, wherein the beverage font lens is substituted with the single panel beverage font lens as presented above.

### DETAILED DESCRIPTION OF DRAWINGS

FIG. 1A shows a front view of the beverage font lens 1 according to an embodiment of the present disclosure. The beverage font lens comprises a housing 2, said housing comprising a first rounded edge 3, and a stem 5 configured for holding the beverage font lens 1 upright when mounted on a beverage font (not shown). The beverage font lens further comprises a first window 7 and a second window 8 accommodated in the housing 2. These windows are preferably circular.

FIG. 1B shows a top view of the beverage font lens 1 of FIG. 1A. The housing 2 of the beverage font lens may comprise an edge 6 having a convex curvature when the beverage font lens is viewed from above.

FIG. 1C shows a side view of the beverage font lens 1 of FIG. 1A. As seen from this view, the first 7 and second 8 window are preferably flat and integrated into the housing 2. The beverage font lens may comprise the edge 6 protruding from the housing near the stem 5 of the housing.

FIG. 1D shows a bottom view of the beverage font lens 1 of FIG. 1A. The stem 5 is preferably circular in cross-section as seen from this view. FIG. 1D shows that the housing 2 has a second outer edge 4. The second outer edge can also be straight or have any other curvature.

FIG. 2 shows in 3D perspective the beverage font lens 1 of FIGS. 1A-1D.

FIG. 3a shows the beverage font lens 1 when mounted on a beverage font 18, which may be part of a beverage dispensing system. In this example, the beverage font 18 comprises three beverage font lenses, each beverage font lens associated with a tap handle 19 controlling the operation of a tapping head (not shown) for dispensing a beverage. In this figure, the beverage font is imaged from the customer side. Hence, the customer display panel 9 of each beverage font lens 1 is visible from this view. In this example, the three customer display panels 9 collectively display the message “Happy hour @ 17”. Other information may be provided to the customers being served at the bar.

FIG. 3b shows the customer side and the operator side of the beverage font lens 1, respectively. In this example, the message “Hour” is displayed to the customer, whereas various information relating to the beverage dispensing system is displayed to the operator, typically a bartender. The customer display panel 9 is preferably a rounded display, even more preferably a circular display. The operator display panel 10 may similarly be a rounded display; however, in the embodiment shown in this figure, the operator display panel is rectangular. The operator display panel 10 may provide information such as the remaining volume of beverage in the beverage container, the brand of the beverage being dispensed, the dispensed volume of beverage during a time interval, and other information.

FIG. 4a shows one beverage font lens 1′ surrounded by two other beverage font lenses 1″ seen from the operator side. The beverage font lens 1′ and the two other beverage font lenses 1″ are situated on top of a beverage font (not shown) with corresponding beverage container (not shown).

The two beverage font lenses 1″ can be standard beverage font lenses, where a picture showing the brand and/or type of the beverage served at the beverage font is illuminated from within the beverage font lens by an LED light source, or can comprise display screens on the customer side for showing still or moving pictures about the brand and/or type of the beverage served at the beverage font or advertisement.

The customer side of the beverage font lens 1′ can have a display panel (not shown) with any combination of or all the embodiments and advantages presented in this application regarding the display screen on the customer side.

Compared to the operator display panel of the beverage font lens 1 shown in FIG. 3b, the operator display panel 10 of the beverage font lens 1′ shows an arrow 28 to tell the operator, to which beverage font and beverage container the operator information on the operator display panel 10 relates. In this case, where the arrow 28 points to the right, the operator information regards the beverage font and beverage container to the right. An arrow pointing downward or an arrow pointing to the left would shows that the operator information relates to the beverage font and beverage container in the middle or to the left, respectively. Alternatives to the arrow could be a light source on top of each of the three beverage font lenses, where a lit light source will indicate that the operator information relates to the beverage font and beverage container with the lit light source. Alternatively, three light sources only on top of the beverage font lens 1′ would also be able to show the operator, to which beverage font and beverage container the operator information relates. There other suitable alternatives.

FIG. 4b shows a first substrate 29 and a second substrate 30, where the first substrate 29 is substantially round and the second substrate 30 is also substantially round with substantially the same size as the first substrate 29 except for a protrusion 31.

FIG. 4c shows the first substrate 29 in front of the second substrate 30.

FIG. 4d shows the first substrate 29 in front of the second substrate 30. Between the first substrate 29 and the second substrate 30 are located transistors (not shown) for controlling what is shown on the display panels of the first substrate 29 and the second substrate 30.

The protrusion 31 forms a contact area where a flexible PCB or FPC 32 can be mounted, which carries the driver circuit 33 for communicating to the microcontroller located on the main PCB (not shown), so that the display driver circuit 33 can electronically connect to the transistors located between the two substrates and control the display panels.

FIG. 4e shows an exploded view of an embodiment of the beverage font lens 1. The beverage font lens 1 comprises a housing 2. The housing enclose a customer display panel 9 and an operator display panel 10 facing opposite directions. To protect the customer display panel and the operator display panel, a first window (not shown) and a second window 8 are positioned over the customer display panel and the operator display panel, respectively, on the outside.

The operator display panel 10 can be e.g. glued to the second window 8 in a central position, where the second window is held in place (e.g. glued) by a display frame 35 or the second window is glued to the housing 2. The beverage font lens 1 may also comprise an antenna 36 like a RFID interrogator antenna for the RFID reader for transmitting and receiving a signal to and from an RFID tag worn by an operator for wirelessly identifying the operator in close proximity to the beverage font lens and/or operating the beverage font. When the RFID tag worn by the operator is identified and approved, the beverage font lens 1 can be activated to present operator information about the beverage dispensing system. The operator can have personal settings so that the particular information set for the RFID tag of the operator is shown in the beverage font lens. The RFID tag can also be used to unlock the beverage font lens so that the operator information when there is a RFID tag nearby. The RFID tag can also be used to switch the beverage font lens from showing customer information to operator information when there is a RFID tag nearby, which will beneficial when the beverage font lens has only one single display panel.

The antenna 36 can also transmit and receive signals to and from an RFID tag of a beverage container, where the RFID tag comprises information about the beverage of the beverage container. If the beverage container is installed in the beverage dispensing system far away from the beverage font lens, the RFID tag of the installed beverage container can be detached from the beverage container and brought closer to the beverage font lens so that the RFID reader can communicate with the RFID tag of the installed beverage container. The antenna 36 can alternatively be an NFC antenna for an NFC reader for transmitting and receiving a signal to and from an NFC tag of a beverage container.

The beverage font lens 1 may also comprise a PCB frame 38 for holding a PCB 37 having a MCU 16.

The customer display panel 9 comprises a first substrate 29 (not shown) and a second substrate 30 as shown in FIGS. 4b-4d, where the second substrate has a protrusion 31 with an electronic contact area 39 onto which the flexible printed circuit (FPC) (not shown) can be connected.

FIG. 5 shows the data flow in a system for displaying data of a beverage dispensing system. The system is furthermore capable of obtaining data of the beverage dispensing system, processing the data, and displaying the data and/or the processed data to one or more customers and/or operators of the beverage dispensing system via one or more display panels. The system preferably comprises one or more measuring devices 11, one or more electronic devices 14, a cloud server 15, one or more microcontroller units 16, and one or more display panels 9,10. The arrows indicate the preferred direction of the data, and the dashed arrows indicate alternative routes of the data. In other words, the data obtained by the measuring device(s) 11 may be transmitted directly to the microcontroller unit(s). Alternatively, the data may be collected and/or processed in one or more electronic devices 14 and subsequently transmitted to the one or more microcontroller units 16, i.e. without the use of a cloud server 15. In a preferred embodiment, the data is processed in a cloud server 15, also referred to as cloud computing, before it is transmitted to the microcontroller units 16 operating the display panel(s).

FIG. 6 shows the data flow in a system for displaying data of a beverage dispensing system. The system is similar to that of FIG. 5, except that this embodiment specifies examples of measuring devices and display panels. Accordingly, the measuring devices may comprise one or more RFID tags 13 and one or more pressure sensor(s) 12 and/or one or more weight sensor 34. The display panels may comprise a customer display panel 9 and an operator display panel 10. Typically, a beverage dispensing system comprises multiple beverage containers. Preferably, a system as indicated in FIG. 6 is provided for each beverage container in the beverage dispensing system, with the exception that only one cloud server 16 is needed independently of the number of beverage containers. Hence, each beverage container is preferably provided with an RFID tag 13 and an electronic device 14 for receiving information from the RFID tag. Information from e.g. the RFID tag 13 may be transmitted to the cloud 15 and/or transmitted directly to a microcontroller unit 16 placed in the beverage font lens, said microcontroller unit comprising two interfaces for connecting and controlling the customer display panel 9 and the operator display panel 10.

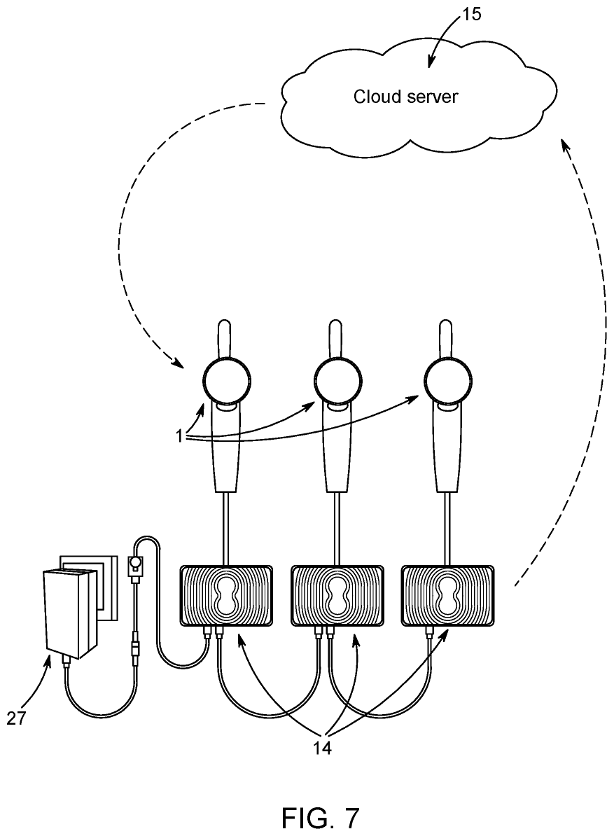

FIG. 7 shows a part of the system for obtaining, processing, and displaying data in the beverage font lenses 1 of a beverage dispensing system. This embodiment shows three electronic devices 14, one for each beverage font lens 1, wherein each of the electronic devices are configured for reading an RFID tag provided by a beverage container fluidly connected to one of the tapping heads. The electronic devices 14 are preferably further configured to receive data from other measuring devices monitoring the beverage dispensing system. As an example, each of the electronic devices are preferably configured to receive pressure data from a pressure sensor measuring the pressure in the inner space of a pressure chamber accommodating a collapsible beverage container. The electronic devices 14 are preferably further configured to process the raw pressure data in order to obtain processed information e.g. relating to the remaining volume of beverage in the beverage container. The raw data and/or the processed data may be transmitted to a cloud server 15, which is preferably configured to store and/or process the data. The data may then be transmitted to the microcontroller units, each unit contained in a beverage font lens 1 mounted on a beverage font of the beverage dispensing system. Information of the beverage dispensing system, said information based on the obtained and/or processed data, may then be displayed in one or more display panels provided in the beverage font lens. The electronic devices 14 are powered by a power source 27.

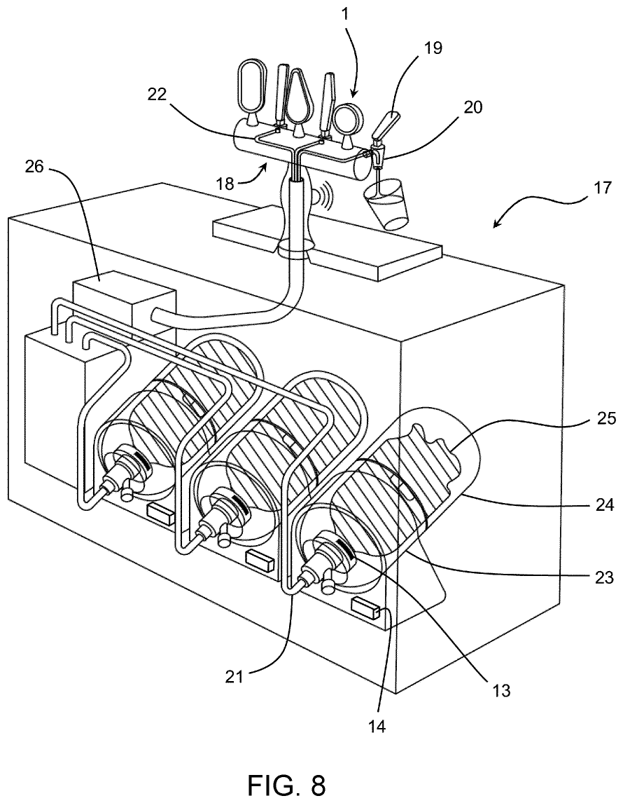

FIG. 8 shows a beverage dispensing system 17 comprising a beverage container 25 inside a pressure chamber comprising a base part 23 and a lid part 24, a tapping line 21 and a beverage line 22 for transporting the beverage to a tapping head 20 of a beverage font 18 when a tap handle 19 is activated. Other types of beverage dispensing systems are also contemplated within the context of the present invention. The beverage dispensing system 17 can also comprise a cooling device 26. Each beverage container 25 comprises an RFID tag 13. An electronic device 14 is configured for reading the RFID tag 13 to identify the beverage in the beverage container 25 regarding brand, type, volume when full etc.

Typically, the beverage dispensing system comprises one beverage font lens 1 for each beverage container. However, less beverage font lenses may be provided for instance if a plurality of the beverage containers contain the same type of beverage. Typically, at least one beverage font lens 1 is provided for each type of beverage. The beverage font lens 1 may display relevant information of the beverage dispensing system and/or the beverage(s) being dispensed as described in more detail elsewhere in this disclosure.

### REFERENCE NUMERALS

1. Beverage font lens
2. Housing
3. First rounded edge
4. Second rounded edge
5. Stem
6. Edge
7. First window
8. Second window
9. Customer display panel
10. Operator display panel
11. Measuring device
12. Pressure sensor
13. RFID tag
14. Electronic device
15. Cloud server
16. Microcontroller unit
17. Beverage dispensing system
18. Beverage font
19. Tap handle
20. Tapping head
21. Tapping line
22. Beverage line
23. Base part
24. Lid part
25. Beverage container
26. Cooling device
27. Power source
28. Arrow
29. First substrate of a display panel
30. Second substrate of a display panel
31. Protrusion
32. Flexible printed circuit
33. Display driver circuit
34. Weight sensor
35. Display frame
36. Antenna
37. Printed circuit board (PCB)
38. PCB frame
39. Electronic contact area

### Further Details of the Invention

1. A beverage font lens (1) comprising a housing (2) accommodating:
a customer display panel (9) embedded in the housing and visible through a first window (7);
an operator display panel (10) embedded in the housing and visible through a second window (8) opposite the first window; and
a microcontroller unit (16) configured to display information on the customer display panel and the operator display panel.

2. The beverage font lens (1) according to item 1, wherein the microcontroller unit (16) comprises a first interface and a second interface, each interface configured to connect an electronic display to the microcontroller unit.

3. The beverage font lens (1) according to item 1 or 2, wherein the microcontroller unit (16) comprises a first interface and a second interface, wherein the customer display panel (9) is connected to the first interface and the operator display panel (10) is connected to the second interface.

4. The beverage font lens (1) according to any one of items 2-3, wherein the first interface is configured to support high-speed image data with a frame rate of at least 24 FPS.

5. The beverage font lens (1) according to any one of items 2-4, wherein the second interface is configured to support low-speed image data with a frame rate of at most 15 FPS.

6. The beverage font lens (1) according to any one of items 2-5, wherein the customer display panel (9) is connected to the microcontroller unit (16) through the first interface, and the operator display panel (10) is connected to the microcontroller unit through the second interface.

7. The beverage font lens (1) according to any one of the preceding items, wherein the customer display panel (9) has a frame rate of at least 24 FPS.

8. The beverage font lens (1) according to any one of the preceding items, wherein the customer display panel (9) and/or the operator display panel (10) is a TFT LCD panel.

9. The beverage font lens (1) according to any one of the preceding items, wherein the customer display panel (9) and/or the operator display panel (10) is an IPS (in-plane switching) panel.

10. The beverage font lens (1) according to any one of the preceding items, wherein the customer display panel (9) is predominantly round.

11. The beverage font lens (1) according to any one of the preceding items, wherein the housing comprises a rounded outer edge.

12. The beverage font lens (1) according to any one of the preceding items, wherein the housing (2) is oval or droplet shaped.

13. The beverage font lens (1) according to item 12, wherein a tapered end of the oval or droplet shape facing the stem (5) of the lens is configured to accommodate the electrical connections inside the housing (2), such as a protrusion (31).

14. The beverage font lens (1) according to any one of the preceding items, wherein the customer display panel (9) and/or the operator display panel (10) comprise a touchscreen.

15. The beverage font lens (1) according to any one of the preceding items, wherein the microcontroller unit (16) is configured for wireless transmission of data or connected to a RF module for wireless communication.

16. The beverage font lens (1) according to item 15, wherein the wireless transmission of data is enabled by any of the following wireless technologies: Bluetooth, Bluetooth Low Energy (BLE), Ultra Wideband (UWB), Wi-Fi, IEEE 802.11ah (Wi-Fi HaLow), GSM, 4G, or 5G.

17. The beverage font lens (1) according to any one of the preceding items, wherein the beverage font lens is configured to be powered by a voltage in the range of 5V to 12 V DC, preferably by 5V DC.

18. The beverage font lens (1) according to any one of the preceding items, wherein the microcontroller unit (16) comprises a power converter for converting the input power to a power suitable for powering the customer display panel (9) and/or the operator display panel (10).

19. The beverage font lens (1) according to any one of the preceding items, wherein the housing (2) is configured for mechanically supporting the first window (7) and the second window (8).

20. The beverage font lens (1) according to any one of the preceding items, wherein the housing (2) comprises a rounded outer edge.

21. The beverage font lens (1) according to any one of the preceding items, wherein the housing (2) comprises a stem (5) configured for holding the beverage font lens upright when mounted on a beverage font (18).

22. The beverage font lens (1) according to any one of the preceding items, wherein the first and/or the second window (7/8) is circular.

23. The beverage font lens (1) according to any one of the preceding items, wherein the first (7) and/or the second (8) window comprises a material that is transparent to the radio-frequencies commonly used in Radio-frequency identification (RFID) systems and/or to the frequency range(s) typically used for WiFi and/or for Bluetooth.

24. The beverage font lens (1) according to any one of the preceding items, wherein the beverage font lens is configured for being mounted on a beverage font (18) of a beverage dispensing system (17) comprising one or more beverage containers (25).

25. The beverage font lens (1) according to any one of the preceding items, wherein the microcontroller unit (16) is configured for wirelessly receiving information related to the one or more beverage containers (25).

26. The beverage font lens (1) according to item 25, wherein the information is received from a cloud server (15).

27. The beverage font lens (1) according to item 25, wherein the information is received from one or more electronic device(s) (14), each electronic device in communication with one or more measuring devices (11) configured for monitoring the beverage dispensing system (17).

28. The beverage font lens (1) according to any one of the items 24-27, wherein the operator display panel (10) is configured to display operator information related to the beverage dispensing system (17).

29. The beverage font lens (1) according to item 28, wherein the operator information comprise any of the following content: the remaining volume of beverage in the beverage container(s) (25), the type of beverage in the beverage container(s), when a beverage container is connected/disconnected to the beverage font (18), the remaining shelf life of a beverage container, cleaning alerts, the dispensed volume of beverage from the beverage container(s) throughout a given time interval, or combinations thereof.

30. The beverage font lens (1) according to any of the items 28-29, wherein the operator information is updated automatically and continuously in real-time to reflect a current status of the beverage dispensing system (17).

31. The beverage font lens (1) according to any one of the preceding items, wherein the customer display panel (9) is configured for displaying customer information.

32. The beverage font lens (1) according to item 31, wherein the customer information comprise any of the following content: the brand of the beverage(s) contained in the beverage container(s) (25), advertisements, messages, symbols, images, videos, or combinations thereof.

33. The beverage font lens (1) according to any one of the items 31-32, wherein the customer information is configured to be updated manually and/or automatically from a computing device wirelessly connected to the beverage font lens and/or from a remote server.

34. The beverage font lens (1) according to any one of the items 31-32, wherein the customer information is updated automatically from a cloud server (15) and/or from a computing device wirelessly connected to the beverage font lens.

35. The beverage font lens (1) according to any one of the preceding items, wherein the beverage font lens further comprises an electronic reader configured to wirelessly identify an operator in close proximity to the beverage font (18) and/or operating the beverage font.

36. The beverage font lens (1) according to item 35, wherein said wireless identification is based on radio-frequency identification (RFID).

37. The beverage font lens (1) according to any one of the items 35-36, wherein the electronic reader is an RFID reader or an NFC reader.

38. The beverage font lens (1) according to item 37, wherein the RFID reader or the NFC reader is configured to read an RFID tag or an NFC tag worn by an operator.

39. The beverage font lens (1) according to any one of the items 35-38, wherein the first window (7) and/or the second window (8) comprises a material that is transparent to the radio-frequencies emitted by the electronic reader.

40. The beverage font lens (1) according to any one of the preceding items, wherein the customer display panel (9) has a higher resolution than the operator display panel (10).

41. The beverage font lens (1) according to any one of the items 28-40, wherein the operator display panel (10) is configured to display the operator information of two, three or more beverage containers (25).

42. A beverage dispensing system (17) for dispensing a beverage, said beverage dispensing system comprising:
one or more beverage containers (25) for accommodating a beverage, wherein the beverage container(s) comprise(s) a beverage outlet,
a pressure source configured to expel the beverage out of the beverage container(s) through the beverage outlet,
a beverage font (18) comprising one or more tapping heads for extracting the beverage from the beverage container(s),
a tapping line (21) extending from said beverage outlet to said beverage font, said tapping line comprising one or more beverage lines (22), and
a beverage font lens (1) according to any one of the items 1-41.

43. The beverage dispensing system (17) according to item 42, wherein the beverage font lens (1) is mounted on the beverage font (18) or on a tap handle (19).

44. The beverage dispensing system (17) according to any one of the items 42-43, wherein the beverage dispensing system comprises one or more measuring devices (11), each measuring device configured to monitor at least one physical quantity of the tapping line (21) and/or the beverage container (25).

45. The beverage dispensing system (17) according to item 44, wherein the one or more measuring devices (11) include a pressure sensor (12) configured to monitor the pressure in the tapping line (21) or a weight sensor configured to monitor the weight of the beverage in the beverage container.

46. The beverage dispensing system (17) according to any one of the items 44-45, wherein the beverage dispensing system comprises one or more electronic devices (14), each electronic device configured to receive and process data received from the one or more measuring devices (11).

47. The beverage dispensing system (17) according to any one of the items 42-46, wherein the one or more beverage containers are bag in container systems, where the space between the container and the beverage filled bag inside the container is pressurized to dispense the beverage from the bag through a beverage outlet.

48. The beverage dispensing system (17) according to any one of the items 42-46, wherein the one or more beverage containers (25) are collapsible beverage containers, each beverage container accommodated in a sealed inner space of a pressure chamber, each beverage container having a beverage outlet connectable to a base part (23) of the pressure chamber.

49. The beverage dispensing system (17) according to item 47 or 48, wherein the beverage dispensing system comprises one or more pressure sensor(s) (12) configured to monitor the pressure in each of the sealed inner spaces or in the space between the container and the bag.

50. The beverage dispensing system (17) according to item 49, wherein the one or more electronic devices (14) each are configured to process pressure data received from the one or more pressure sensors (12).

51. The beverage dispensing system (17) according to item 50, wherein the electronic device (14) is configured to determine the volume of a dispensed beverage and/or the remaining volume in the corresponding beverage container (25), wherein said determination is based on the measured pressure in the sealed inner space or in the space between the container and the bag.

52. The beverage dispensing system (17) according to any one of the items 46-51, wherein the one or more electronic devices (14) are configured to transmit data wirelessly.

53. The beverage dispensing system (17) according to any one of the items 46-52, wherein the one or more electronic devices (14) are configured to transmit data to a cloud server (15).

54. The beverage dispensing system (17) according to any one of the items 46-53, wherein each of the one or more electronic devices (14) are configured to automatically identify information related to the contents of the one or more beverage container(s) (25).

55. The beverage dispensing system (17) according to item 54, wherein the information comprise any of the following information: the type of beverage, the brand of the beverage, the date of the batch of the beverage, the ‘best before’ date or combinations thereof.

56. The beverage dispensing system (17) according to any of the items 54-55, wherein the identification is provided by radio-frequency identification (RFID).

57. The beverage dispensing system (17) according to any of the items 54-56, wherein each beverage container (25) comprises an RFID tag (13) which is readable by the one or more electronic devices (14).

58. The beverage dispensing system (17) according to item 57, wherein each electronic device (14) comprises an RFID reader configured to read one or more RFID tag(s) (13), each tag provided by the one or more beverage container(s) (25).

59. The beverage dispensing system (17) according to item 58, wherein the RFID reader is located in the inner space of the pressure chamber, preferable in the same end as the beverage outlet of the beverage container would be positioned when in operation.

60. The beverage font lens according to any one of the preceding claims, wherein the beverage font lens is only wiredly connected to a power source.

61. The beverage font lens according to item 60, wherein the wiring providing power to the beverage font lens is the existing wiring in the beverage font (18) used to power a non-digital LED lens.

62. A beverage font lens comprising a housing accommodating:
a single panel embedded in the housing and visible through a window;
a microcontroller unit configured to display information on the single display panel,
   wherein microcontroller unit is configured in a standard mode to display customer relevant information, such as brand logo, on the single display panel, and in an activated mood to display operator relevant information related to a beverage dispensing system.

63. The beverage font lens according to item 62, wherein the microcontroller unit is configured to change from the standard mode to the activated mode, when
a sensor wiredly or wirelessly connected to the microcontroller detects that beverage container is empty or nearly (below a predetermined ratio of the full beverage container) empty,
the beverage dispensing system needs to be cleaned,
an operator pour beverage from the beverage dispensing system,
the panel is touched,
a button wiredly or wirelessly connected to the microcontroller and preferably positioned on the beverage font lens is pressed,
a motion sensor wiredly or wirelessly connected to the microcontroller and preferably comprised by the beverage font lens senses motion of a person nearby, or
a proximity sensor, like a capacitive sensor or an IR sensor, wiredly or wirelessly connected to the microcontroller and preferably comprised by the beverage font lens senses.

64. The beverage font lens according to item 62 or 63, wherein the beverage font lens has any combination of features presented in the preceding items 1-61, except that there is a single panel.

65. The beverage dispensing system (17) according to any one of items 42 to 59, wherein the beverage font lens is substituted with the single panel beverage font lens according to any one of items 62 to 64.

66. A beverage font comprising the beverage font lens according to any of the claims 1-41, 60-64, wherein the beverage font lens is
fixedly connected to the beverage font, or
connected to the beverage font but not on a tapping handle.

1.-16. (canceled)

17. A beverage font lens comprising a housing accommodating:
a customer display panel embedded in the housing and visible through a first window;
an operator display panel embedded in the housing and visible through a second window opposite the first window; and
a microcontroller unit configured to cause display of information on the customer display panel and the operator display panel.

18. The beverage font lens according to claim 17, wherein the microcontroller unit comprises a first interface and a second interface.

19. The beverage font lens according to claim 18, wherein the customer display panel is connected to the first interface and the operator display panel is connected to the second interface. (New) The beverage font lens according to claim 17, wherein the customer display panel has a higher resolution than the operator display panel.

21. The beverage font lens according to claim 17, wherein the customer display panel has a frame rate of at least 24 FPS.

22. The beverage font lens according to according to claim 18, wherein the first interface is configured to support high-speed image data with a frame rate of at least 24 FPS and the second interface is configured to support low-speed image data with a frame rate of at most 15 FPS.

23. The beverage font lens according to claim 17, wherein the microcontroller unit is configured for wireless transmission of data or connected to a RF module for wireless communication.

24. The beverage font lens according to claim 17, wherein the housing comprises a rounded outer edge, such as an oval or drop shape.

25. The beverage font lens according to claim 17, wherein the first window is essentially circular, the second window is essentially circular, or both the first and second windows are essentially circular.

26. The beverage font lens according to claim 17, wherein the first window, the second window or both the first window and second window comprise a material that is transparent to: a) the radio-frequencies commonly used in radio-frequency identification (RFID) systems, b) the frequency range(s) typically used for WiFi and/or for Bluetooth, or c) both a) and b).

27. The beverage font lens according to claim 17, wherein the beverage font lens is configured for being mounted on a beverage font of a beverage dispensing system comprising one or more beverage containers.

28. The beverage font lens according to claim 27, wherein the microcontroller unit is configured for wirelessly receiving information related to said one or more beverage containers.

29. The beverage font lens according to claim 17, wherein the only wiring to the beverage font lens is for receiving electric power. (New) The beverage font lens according to claim 28, wherein the information is received from: a) a cloud server, b) one or more electronic devices, or c) both a cloud server and one more electronic devices.

31. The beverage font lens according to claim 30, wherein each of the electronic devices is in communication with one or more measuring devices configured for monitoring the beverage dispensing system.

32. The beverage font lens according to claim 27, wherein the operator display panel is configured to display operator information related to the beverage dispensing system, said operator information comprising any of the following content: the remaining volume of beverage in the beverage container(s), the type of beverage in the beverage container(s), when a beverage container is connected/disconnected to the beverage font, cleaning alerts, the dispensed volume of beverage from the beverage container(s) throughout a given time interval, or combinations thereof.

33. The beverage font lens according to claim 32, wherein the operator information is updated automatically and continuously in real-time to reflect a current status of the beverage dispensing system.

34. The beverage font lens according to claim 17, wherein the beverage font lens further comprises an electronic reader configured to wirelessly identify an operator in close proximity to the beverage font, an operator operating the beverage font, or both an operator in close proximity to the beverage font and an operator operating the beverage font.

35. The beverage font lens according to claim 34, wherein said wireless identification is based on radio-frequency identification (RFID).

36. A beverage font comprising:
a beverage font lens fixedly connected to the beverage font or connected to the beverage font but not on a tapping handle, wherein the beverage font lens comprises a housing accommodating:
a customer display panel embedded in the housing and visible through a first window;
an operator display panel embedded in the housing and visible through a second window opposite the first window; and
a microcontroller unit configured to cause display of information on the customer display panel and the operator display panel.
